(19) United States
(12) Patent Application Publication
(10) Pub. No.: US 2009/0271244 A1
(43) Pub. Date: Oct. 29, 2009

(54) SITUATION-AWARE AD-HOC SOCIAL INTERACTION

(75) Inventors: Swaroop Kalasapur, Santa Clara, CA (US); Yu Song, Pleasanton, CA (US); Doreen Cheng, San Jose, CA (US); Sangoh Jeong, Palo Alto, CA (US)

Correspondence Address: Beyer Law Group LLP, P.O. BOX 1687, Cupertino, CA, 95015-1687, US

(73) Assignee: Samsung Electronics Co., Ltd., Suwon City (KR)

(21) Appl. No.: 12/109,878

(22) Filed: Apr. 25, 2008

(51) Int. Cl. G06Q 10/00

(52) U.S. Cl. 705/10

(57) ABSTRACT

In one embodiment, a method for social networking is provided. A social profile is automatically built for a first user by monitoring the usage of an electronic device operated by the first user. A social network appropriate for the first user is determined by examining the first user's social profile. The appropriate social network is provided to the first user to join if the appropriate social network is available for the first user to join.

### BACKGROUND OF THE INVENTION

1. Field of the Invention

The present invention relates to social networking. More particularly, the present invention relates to situation-aware ad-hoc social interaction.

2. Description of the Related Art

A social network service uses software to build online social networks for communities of people who share interests and activities or who are interested in exploring the interests and activities of others. These online networks are often referred to as social networking sites.

Most services are primarily web based and provide a collection of various ways for users to interact, such as chat, messaging, email, video, voice chat, file sharing, blogging, discussion groups, and so on. Various social networking websites are being used by millions of people everyday on a regular basis and it now seems that social networking is a part of everyday life.

The main types of social networking services are those which contain directories of some categories (such as former classmates), means to connect with friends (usually with self-description pages), and recommender systems linked to trust. Popular methods now combine many of these, with MySpace and Facebook being the most widely used in North America, Bebo, MySpace, Skyblog , Facebook and Hi5 in parts of Europe, Orkut and Hi5 in South America and Central America, Friendster, Orkut and CyWorld in Asia and the Pacific Islands and LiveJournal in Russia.

In general, social networking services allow users to create a profile for themselves, and can be internal or external. Both types can increase the feeling of community among people. An Internal Social Network (ISN) is a closed/private community that consists of a group of people within a company, association, society, education provider and organization or even an “invite only” group created by a user in an External Social Network (ESN). An ESN is open/public and available to all web users to communicate and are designed to attract advertisers. Users can upload a picture of themselves and can often be “friends” with other users. In most social networking services, both users must confirm that they are friends before they are linked. For example, if Alice lists Bob as a friend, then Bob would have to approve Alice's friend request before they are listed as friends. Some social networking sites have a “favorites” feature that does not need approval from the other user. Social networks usually have privacy controls that allows the user to choose who can view their profile or contact them, etc.

Some social networks have additional features, such as the ability to create groups that share common interests or affiliations, upload videos, and hold discussions in forums. Geosocial networking co-opts internet mapping services to organize user participation around geographic features and their attributes.

Few social networks currently charge money for membership. In part, this may be because social networking is a relatively new service, and the value of using them has not been firmly established in customers' minds. Companies such as MySpace and Facebook sell online advertising on their site. Hence, they are seeking large memberships, and charging for membership would be counter productive. Some believe that the deeper information that the sites have on each user will allow much better targeted advertising than any other site can currently provide. Sites are also seeking other ways to make money, such as by creating an online marketplace (e.g., Facebook's Marketplace) or by selling professional information and social connections to businesses: such as Linkedln.

Social networks operate under an autonomous business model, in which a social network's members serve dual roles as both the suppliers and the consumers of content. This is in contrast to a traditional business model, where the suppliers and consumers are distinct agents. Revenue is typically gained in the autonomous business model via advertisements, but subscription-based revenue is possible when membership and content levels are sufficiently high.

In recent years, computing systems have become more portable and mobile. As a result, various mobile and handheld devices have been made available. By way of example, wireless phones, media players, Personal Digital Assistants (PDA's) are widely used today. Generally, a mobile or a handheld device (also known as handheld computer or simply handheld) can be a pocket-sized computing device, typically utilizing a small visual display screen for user output and a miniaturized keyboard for user input. In the case of a Personal Digital Assistant (PDA), the input and output can be combined into a touch-screen interface.

In particular, mobile communication devices (e.g., mobile phones) have become extremely popular. Some mobile communication devices (e.g., Smartphones) offer computing environments that are similar to that provided by a Personal Computer (PC). As such, a Smartphone can effectively provide a complete operating system as a standardized interface and platform for application developers. Given the popularity of mobile communication devices, telecommunication is discussed in greater detail below.

Generally, a mobile phone or cell phone can be a long-range, portable electronic device used for mobile communication. In addition to the standard voice function of a telephone, current mobile phones can support many additional services such as SMS for text messaging, email, packet switching for access to the Internet, and MMS for sending and receiving photos and video. Most current mobile phones connect to a cellular network of base stations (cell sites), which is in turn interconnected to the public switched telephone network (PSTN) (one exception is satellite phones).

The Short Message Service (SMS), often called text messaging, is a means of sending short messages to and from mobile phones. SMS was originally defined as part of the GSM series of standards in 1985 as a means of sending messages of up to 160 characters, to and from Global System for Mobile communications (GSM) mobile handsets. Since then, support for the service has expanded to include alternative mobile standards such as ANSI CDMA networks and Digital AMPS, satellite and landline networks. Most SMS messages are mobile-to-mobile text messages, though the standard supports other types of broadcast messaging as well. The term SMS is frequently used in a non-technical sense to refer to the text messages themselves, particularly in non-English-speaking European countries where the GSM system is well-established.

Multimedia Messaging Service (MMS) is a relatively more modern standard for telephony messaging systems that allows sending messages that include multimedia objects (images, audio, video, rich text) and not just text as in Short Message Service (SMS). It can be deployed in cellular networks along with other messaging systems like SMS, Mobile Instant Messaging and Mobile E-mal. Its main standardization effort is done by 3GPP, 3GPP2 and Open Mobile Alliance (OMA).

While primarily intended for communication, mobile devices have scaled beyond their original intent, packing advanced capabilities such as handling multimedia, capturing and storing information, etc. In light of this development, mobile devices are increasingly used for interacting with people and exchanging information.

### SUMMARY OF THE INVENTION

In one embodiment, a method for social networking is provided. A social profile is automatically built for a first user by monitoring the usage of an electronic device operated by the first user. A social network appropriate for the first user is determined by examining the first user's social profile. The appropriate social network is provided to the first user to join if the appropriate social network is available for the first user to join.

In another embodiment, a system for social networking is provided, the system comprising: an interaction store; a social interaction tracker coupled to the interaction store and configured to monitor the usage of an electronic device operated by the first user and store information regarding the usage in the interaction store; an interest store; an interest generator coupled to the interaction store and the interest store and configured to generate interests for the first user based on the information regarding the usage stored in the interaction store and store the interests in the interest store; a social network manager configured to determine a social network appropriate for the first user by examining the first user's social profile and provide the appropriate social network to the first user to join if the appropriate social network is available for the first user to join.

In another embodiment, a system for social networking is provided, the system comprising: means for automatically building a social profile for a first user by monitoring the usage of an electronic device operated by the first user; means for determining a social network appropriate for the first user by examining the first user's social profile; and means for providing the appropriate social network to the first user to join if the appropriate social network is available for the first user to join.

In another embodiment, a program storage device readable by a machine tangibly embodying a program of instructions executable by the machine to perform a method for social networking is provided, the method comprising: automatically building a social profile for a first user by monitoring the usage of an electronic device operated by the first user; determining a social network appropriate for the first user by examining the first user's social profile; and providing the appropriate social network to the first user to join if the appropriate social network is available for the first user to join.

### BRIEF DESCRIPTION OF THE DRAWINGS

FIG. 1 is a diagram illustrating the building of a user's social profile in accordance with an embodiment of the present invention.

FIG. 2 is a diagram illustrating a system for utilizing a generated profile to enable social applications on mobile devices without involving servers.

FIG. 3 is an example apparatus for server-based mobile social network management in accordance with an embodiment of the present invention.

FIG. 4 is a flow diagram illustrating a method for social networking in accordance with an embodiment of the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

In an embodiment of the present invention, social interactions among users are derived with the help of the devices (e.g., mobile devices) operated by the users. Existing social networking services require users to proactively approach such services and avail their facilities. In an embodiment of the present invention, social networks are automatically recommended to the user based on derived information from the user devices. Thus, social networks may be formed in an ad hoc fashion without requiring users to first subscribe or register to the services and then to login to join the network.

Existing social networking services also require users to manually provide and update profiles in order to identify “similar” people. In an embodiment of the present invention, “similar” people may be automatically detected based on the derived information from the user devices.

User profiles may additionally be generated or updated automatically, freeing the user from having to manually specify or update their profile. Existing social networking services also fail to take into account the situation of the user and/or the device. In an embodiment of the present invention, these situations are taken into account when recommending “similar” people or services. Potential social networking candidates may be based on the current situation (including the location) of the user. An embodiment of the present invention also allows for social networks of any topics to be formed based on matched interests, not limited by topics provided by the social networking service.

For purposes of this document, the interactions between two or more people using their devices may be called social interactions. Examples of such interactions include playing games, sending and/or receiving pictures, exchanging VCards, documents, and messages, and so on. Groupings of social interactions may be known as social networks.

In one embodiment of the present invention, social networks are formed among people who are physically close to each other so that it is possible to grow the interactions beyond the boundaries of the device. Devices in physical proximity can be captured by use of short range wireless technologies, such as Bluetooth, ad-hoc WiFi, etc, or by direct links such as USB and/or Firewire/IEEE 1394.

In an embodiment of the present invention, two different phases may be utilized. In the first phase, data is collected from usage information regarding the user's operation of an electronic device. This data is then analyzed to build a profile for the user. This first phase may also be known as the “building” phase. In the second phase, the collected profile is utilized to discover other users with matching profiles. This phase of building the profile may be an ongoing process, with the profile getting updated continuously. This phase may also be known as the “runtime” phase.

The electronic devices whose usage is monitored may be any type of electronic device. One common use for the present invention would be to monitor usage of mobile devices, such as mobile phones, personal data assistants (PDAs), laptop computers, and the like. In some embodiments, information from non-mobile devices such as desktop computer could be utilized, either in lieu of or in conjunction with information from mobile device. The electronic devices may also be other types of devices where usage information could be monitored. With electronic devices getting more and more advanced, the number of potential types of electronic devices whose usage could be monitored is nearly unlimited. Some examples include watches, televisions, telephones, answering machines, scales, refrigerators, ovens, automobiles, video game systems, printers, radios, cd players, smart home devices, mobile music players, etc.

The first phase may be described as generic framework that can be used by various social networking applications during the second phase. Typical advanced mobile users perform a number of activities through their mobile devices. Many of these activities involve explicit interaction with devices owned by other users. Examples of such interactions in professional environments can include exchanging VCards, documents, and pictures. Some examples in personal environments include exchanging songs, videos, playing games, etc.

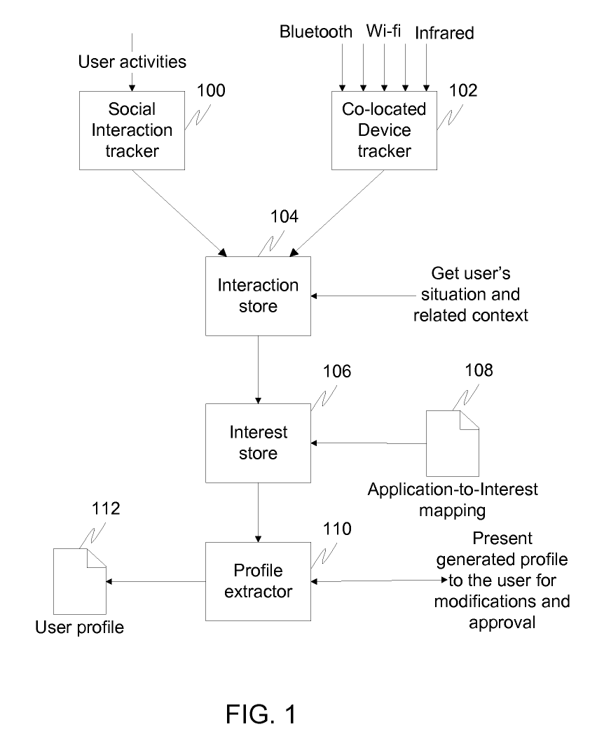

FIG. 1 is a diagram illustrating the building of a user's social profile in accordance with an embodiment of the present invention. A social interaction tracker 100 may observe user activities and keep track of the social interactions of the user. A co-located device tracker 102 may periodically gather information about co-located devices. Co-located devices are devices that are located within a specified distance of one another. This distance may be any measure. For example, in one embodiment co-located devices may be devices located in the same room (useful in, for example, a club environment where social networks of other club patrons could be automatically recommended). In another embodiment, co-located devices may be located in the same building (useful in, for example, an office environment, where social networks of fellow employees could be automatically recommended.). In another embodiment, co-located devices may be located in the same city.

The user's current context and the situation may also be gathered though use of a situation recognizer (not pictured). Context refers to the situation in which the user and/or device the user is operating. For example, the context may include the location of the user—whether the user is home, at the office, or elsewhere. The context may also include the time of day—for example, whether it is morning, afternoon, or evening. One of ordinary skill in the art will recognize that there may be many other types of information captured by the context and nothing in this document shall be read as limiting the invention to any particular type of information.

An interaction store 104 may collect the tracked information and store it for later use. An interest store 106 may then keep each user's interest profile. It may periodically examine the interaction history, and with the help of interaction-interest mapping definitions 108, may classify the interactions into various interests, with reference to the context and/or situation under which the interactions took place. Here, it is assumed that knowledge for mapping applications (on a user device) into various interest groups is available and can be preloaded and/or updated (through the Internet, for example) into the device. Table 1 below depicts an example representation of the Interest store.

TABLE 1

| Situation | Application Usage | Interest |
|---|---|---|
| 1 | Media player: rock song and | Music, rock, hip-hop |
| | hip-hop song | |
| | Music Store: purchase Hip- | |
| | hop album | |
| 2 | Game Engine: World of | Gaming, Strategy games, |
| | Warcraft, Age of Empires, | first person shooter games |
| | Quake, and Doom | |
| | RSS Blogger: Update | |
| | World of Warcraft blog | |
| 3 | RSS Reader: NFL news, | Sports, Football, Basketball. |
| | NBA news | |
| | Media Player | |

In another embodiment of the present invention, an artificial intelligence engine may be utilized instead of or in combination with predetermined interest-to-situation mappings. The artificial intelligence engine may dynamically determine interests corresponding to the relevant situations. For example, an artificial intelligence engine may extract keywords from web pages or blogs viewed by the user and create interest categories based on those keywords.

A profile extractor 110 may inspect the generated interests along with the associated situation and present them to the user for confirmation. At this point, the user may modify the generated interest profile. The user-approved profile is then stored as the “user profile” 112.

This user profile may be built from scratch, or alternatively the system may simply add to and/or modify a profile that was already created using other means. For example, a user may have set up a profile on an Internet directory web site. This profile may be used and modified to create the user's social profile.

Furthermore, as discussed above, a number of different electronic devices may be monitored to establish the user's usage patterns. For example, the system may monitor applications run on a user's cell phone but also monitor web searches run by the user on his home computer in order to derive information regarding the user's interests.

In phase 2 (the “runtime phase”), the profile built during phase 1 is utilized to enable social applications in a dynamic fashion. Two alternative embodiments are provided in this document, however, one of ordinary skill in the art will recognize that more embodiments are possible in keeping with the spirit of the invention. The first embodiment requires no server while the second embodiment utilizes servers.

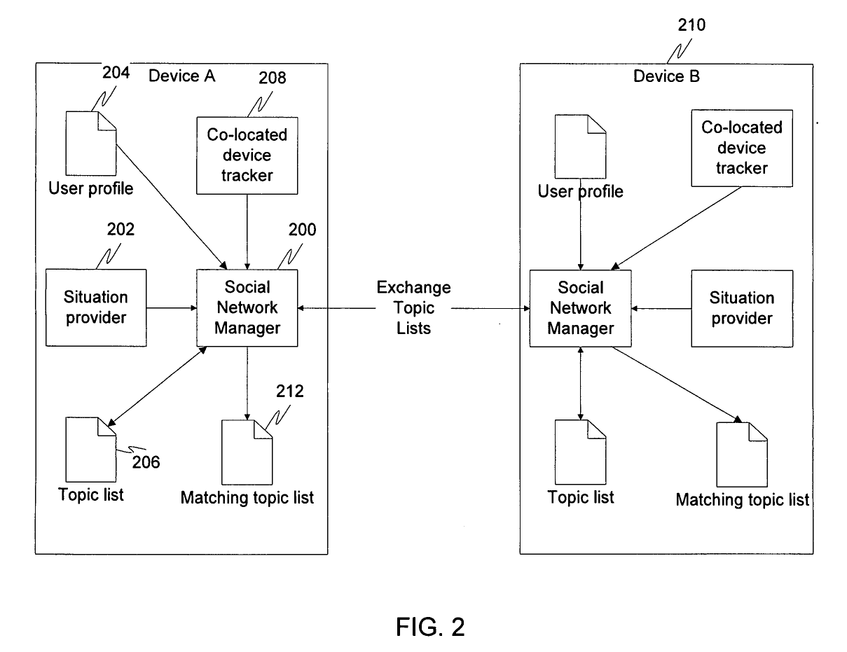

FIG. 2 is a diagram illustrating a system for utilizing a generated profile to enable social applications on mobile devices without involving servers. A social network manager is responsible for identifying any possible social networks with the other co-located devices. The situation provider provides a “current situation” for the user, which tells the social network manager if the user is available for participation in a social network or not. This information can be used to both initiate a social network and also participate in one. The social network manager may inspect the local user profile and come up with a topic list in which the local user is interested, based on the user's current situation. The list is used in the process of matching potential participants in the social network formation process.

The co-located device tracker may provide a list of available co-located devices. The social network manager then sends the topic list to the co-locators and invites them to send lists they have generated. For easy illustration, assume Device A has sent its Topic1 list to the co-locators, including Device B. Any co-located device receiving the Topic list can choose to ignore or compare this list with its own user profile based on its user's situation. For example, Device B may choose to perform the comparison because its user's current situation factors social interaction. Device B may then form a list of matching interests and sends a response back to Device A with the matching topic list. Alternatively, responders can send their entire Topic list and the process of matching can be performed at the initiating device.

After the generation of the matching topic list, the devices may alert their respective users about the found match. At this point, any applications that are designed for social networking can utilize the matching topic list to personalize the experience for the users.

It should be noted that those of ordinary skill in the art could modify this embodiment in many ways to optimize various factors. For example, the process of identifying the matching topic list could be performed at any device that has sufficient resources available for computation, instead of repeating the steps concurrently at each device. Other factors that could be similarly optimized include network bandwidth, number of members in each social network, and number of topics in the list of interests that the system generates.

Those of ordinary skill in the art could also implement the invention by placing more emphasis on privacy. Instead of exchanging raw information such as the topics of interest, for example, the implementation can generate a unique ID for each topic and exchange the encoded list instead.

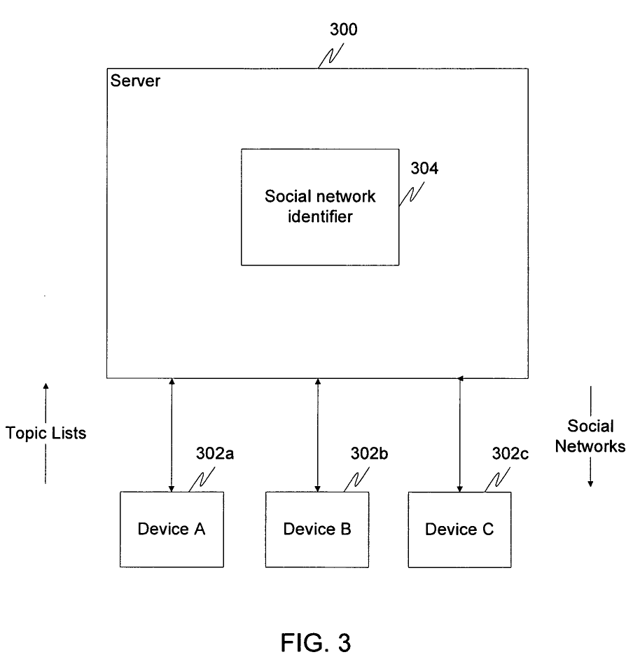

In the second embodiment, an apparatus is presented for performing the social network matching with the support of special purpose device, such as a server. FIG. 3 is an example apparatus for server-based mobile social network management in accordance with an embodiment of the present invention. It should be noted that this server 300 does not need to be a dedicated, special purpose server. The software functionality can readily be implemented on devices already existing in a network, such as a PC.

When a mobile device 302a enters the coverage area of the server 300 and the user's current situation (as provided by the situation provider) permits participating in social networks, the device 302a can register itself with the server 300 and the locally generated topic list can be sent to the server. Alternatively, the server 300 can invite all the user devices 302a, 302b, 302c that are in range to register themselves.

At the server 300, all of the collected topic lists may be compared and potential social networks can be identified based on “common interest” using the social network identifier 304. The resulting social networks may be presented back to the users through their respective devices 302a, 302b, 302c.

It should be noted that those of ordinary skill in the art could modify this embodiment in many ways to optimize various factors. For example, commercial applications such as content pushing, targeted advertising, etc. can be enabled in real-time, based on identified interests for each of the mobile device users. Alternatively, the identified social networks can be used to provide interesting content and to support social networking applications such as networked games, collaborative problem solving, etc. In essence, the identification of the social network provides a foundation from which many different applications could build.

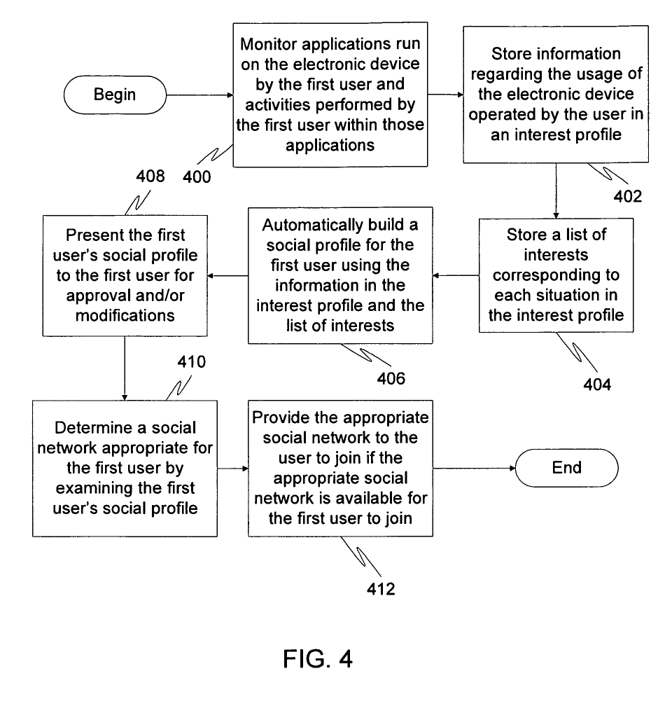

FIG. 4 is a flow diagram illustrating a method for social networking in accordance with an embodiment of the present invention. At 400, applications run on an electronic device by the first user and activities performed by the first user within those applications may be monitored. At 402, information regarding the usage of the electronic device operated by the user is stored in an interest profile. The interest profile may be organized into situations, wherein each situation represents a grouping of similar applications and the contexts in which they were used. At 404, a list of interests corresponding to each situation in the interest profile may be stored. This may be stored by, for example, using predetermined mappings between application usages and interests, or by using dynamically determined interests using an artificial intelligence engine. At 406, a social profile is automatically built for the first user using the information in the interest profile and the list of interests.

At 408, the first user's social profile may be presented to the first user for approval and/or modifications. At 410, a social network appropriate for the first user is determined by examining the first user's social profile. This may include generating a list of topics corresponding to the list of interests and exchanging the list of topics with an electronic device operated by a second user. This may also include inspecting a list of topics forwarded from the electronic device operated by the second user and determining if a topic on the list of topics forwarded from the electronic device operated by the second user matches a topic on the list of topics generated from the first user's list of interest. This may also include determining if the first user's current situation allows for social networking. Alternatively to the exchanging of information directly with the electronic device operated by the second user, the generated list of topics may simply be sent to a server.

It should be noted that it is possible that no existing social networks can be found to match the first user's profile. If that is the case, the system may initiate a social network for the first user. This step could be performed in lieu of 412 in such circumstances.

At 412, the system provides the appropriate social network to the user to join if the appropriate social network is available for the first user to join. This may include determining if a second user in the appropriate social network is operating a device within a predetermined physical distance to the electronic device operated by the first user.

Providing the appropriate social network may take many forms. In a first example, the name of the social network is displayed to the user (or sent to the user's electronic device for display). This allows the user to, for example, accept or reject the suggestion to join the social network. In another example, the user is automatically joined into the network without requiring user interaction. This may be limited by user settings. For example, the user may have previously indicated that it is OK to automatically be joined into social networks related to hobbies, but not for work-related interests. The system may then examine these settings in determining whether to automatically join the user into a network or to provide simply provide the user with a recommendation. Likewise, the user might indicate that it is acceptable to be automatically joined into social networks in certain contexts. For example, the user may indicate that it is acceptable to be automatically joined into a social network when the user is away from home and work.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method for social networking, the method comprising:
automatically building a social profile for a first user by monitoring the usage of an electronic device operated by the first user;
determining a social network appropriate for the first user by examining the first user's social profile; and
providing the appropriate social network to the first user to join if the appropriate social network is available for the first user to join.

2. The method of claim 1, wherein the determining includes determining if a second user in the appropriate social network is operating a device within a predetermined physical distance to the electronic device operated by the first user.

3. The method of claim 1, wherein the automatically building includes monitoring applications run on the electronic device by the first user and activities performed by the first user within those applications.

4. The method of claim 3, further comprising:
storing information regarding the usage of the electronic device operated by the first user in an interest profile.

5. The method of claim 4, wherein the information regarding the usage of the electronic device is organized into situations, wherein each situation represents a grouping of similar applications and the contexts in which they were used.

6. The method of claim 5, further comprising storing a list of interests corresponding to each situation in the interest profile based on predetermined mappings between application usages and interests.

7. The method of claim 5, further comprising storing a list of interests corresponding to each situation in the interest profile based on dynamically determined interests using an artificial intelligence engine.

8. The method of claim 1, further comprising:
presenting the first user's social profile to the first user for approval and/or modifications prior to the determining.

9. The method of claim 1, further comprising generating a list of topics corresponding to the list of interests and exchanging the list of topics with an electronic device operated by a second user.

10. The method of claim 9, further comprising inspecting a list of topics forwarded from the electronic device operated by the second user and determining if a topic on the list of topics forwarded from the electronic device operated by the second user matches a topic on the list of topics generated from the first user's list of interests.

11. The method of claim 10, further comprising determining if the first user's current situation allows for social networking.

12. The method of claim 1, further comprising generating a list of topics corresponding to the list of interests and sending the list of topics to a server.

13. The method of claim 1, further comprising initiating one or more social networks based on the first user's social profile if no appropriate social network is available for the first user to join.

14. A system for social networking, the system comprising:
an interaction store;
a social interaction tracker coupled to the interaction store and configured to monitor the usage of an electronic device operated by the first user and store information regarding the usage in the interaction store;
an interest store;
an interest generator coupled to the interaction store and the interest store and configured to generate interests for the first user based on the information regarding the usage stored in the interaction store and store the interests in the interest store;
a social network manager configured to determine a social network appropriate for the first user by examining the first user's social profile and provide the appropriate social network to the first user to join if the appropriate social network is available for the first user to join.

15. The system of claim 13, wherein the interest generator is further configured to use an application-to-interest mapping to generate interests.

16. The system of claim 13, further comprising a profile extractor coupled to the interest store.

17. The system of claim 13, further comprising a co-located device tracker coupled to the social network manager.

18. The system of claim 13, wherein the social network manager is further configured to initiate one or more social networks based on the first user's social profile if no appropriate social network is available for the first user to join.

19. A system for social networking, the system comprising:
means for automatically building a social profile for a first user by monitoring the usage of an electronic device operated by the first user;
means for determining a social network appropriate for the first user by examining the first user's social profile; and
means for providing the appropriate social network to the first user to join if the appropriate social network is available for the first user to join.

20. A program storage device readable by a machine tangibly embodying a program of instructions executable by the machine to perform a method for social networking, the method comprising:
automatically building a social profile for a first user by monitoring the usage of an electronic device operated by the first user;
determining a social network appropriate for the first user by examining the first user's social profile; and
providing the appropriate social network to the first user to join if the appropriate social network is available for the first user to join.
